(19) United States
(12) Patent Application Publication
(10) Pub. No.: US 2025/0172411 A1
(43) Pub. Date: May 29, 2025

(54) POSITION DETECTION APPARATUS

(71) Applicant: Magnescale Co., Ltd., Kanagawa (JP)

(72) Inventor: Yukisato MIYAZAKI, Kanagawa (JP)

(73) Assignee: Magnescale Co., Ltd., Kanagawa (JP)

(21) Appl. No.: 18/955,694

(22) Filed: Nov. 21, 2024

(30) Foreign Application Priority Data
Nov. 24, 2023 (JP) 2023-198876

(51) Int. Cl. G01D 5/20

(52) U.S. Cl. CPC G01D 5/20

(57) ABSTRACT

Aim

To provide a position detection apparatus capable of detecting a position with a high accuracy and a high resolution.

Solution

Included are: a moving body 13 having an elongated shape, disposed so as to be movable in its longitudinal direction, and having plural detection object portions 15a, 15b, 15c, 15d disposed along the longitudinal direction, the plural detection object portions 15a, 15b, 15c, and 15d having a conductivity; a first detection part 20 and a second detection part 25 arranged along a moving direction of the moving body 13, and disposed so as to be capable of facing the respective detection object portions 15a, 15b, 15c, 15d of the moving body 13 with a predetermined interval therebetween; and a displacement detection parts 40, 41 for detecting a displacement of the moving body 13 by processing output signals from the first detection part 20 and the second detection part 25. The first detection part 20 and the second detection part 25 each include a winding coil 21, 26 for forming an LC circuit and a capacitor 22, 27 connected between opposite end portions of the winding coil 21, 26.

### TECHNICAL FIELD

The present teaching relates to a contact-type position detection apparatus.

### BACKGROUND ART

Conventionally known as a contact-type position detection apparatus is a position detector disclosed in Japanese Patent Application Laid-Open No. 2003-161635. The position detector includes a coil having a hollow cylindrical shape, and a shaft-like moving body inserted through the coil, the shaft-like moving body being movable in the coil. The shaft-like moving body has, on its outer circumferential surface, a pattern having a conductivity or different magnetic resistances. The pattern is formed so as to have its width decrease or increase along the axial direction of the shaft-like moving body.

The position detector is configured to detect a displacement of the shaft-like moving body by periodically applying a square wave to the coil. As the shaft-like moving body moves, an overlap distance or an overlap area between the coil and the pattern changes in accordance with the displacement, and thus the inductance of the coil changes, so that an attenuation state of the square wave changes. By measuring the attenuation state of the square wave, therefore, the displacement of the shaft-like moving body in a linear direction can be detected.

The position detector makes use of a phenomenon in which the inductance of the coil is changed by an induced current that is generated in the shaft-like moving body due to the positional relationship between the coil and the shaft-like moving body, which is a conductor. The position detector is configured to detect the displacement of the shaft-like moving body by extracting the change in inductance of the coil as a frequency component.

### CITATION LIST

### Patent Literature

PTL 1: Japanese Patent Application Laid-Open No. 2003-161635

### SUMMARY OF INVENTION

### Technical Problem

In the conventional position detector described above, the resolution in position detection is obtained as Δf/Δd, where Δd represents the amount of change (amount of displacement) of the position of the shaft-like moving body, and Δf represents a change in frequency between before and after the change of the position of the shaft-like moving body. To increase the resolution, the change (Δf) in frequency needs to be increased.

On the other hand, to detect a position over a long distance, it is required that a coil length (the length of the coil in its width direction) be long; however, there is a characteristic in which a frequency change that allows a change in inductance of the coil to be extracted does not increase in proportion to the length of the coil, but on the contrary, increasing the coil length for the purpose of a long-distance position detection requires a low resolution in position detection from the viewpoint of ensuring a measurement accuracy.

The present teaching, which is made in view of the actual circumstances as referred to above, aims to provide a position detection apparatus capable of detecting a position with a high accuracy and a high resolution even in a case of a long-distance detection.

### Solution to Problem

To attain the aim stated above, the present teaching is directed to a position detection apparatus including:
a moving body having an elongated shape, the moving body being disposed so as to be movable in its longitudinal direction, the moving body having plural detection object portions disposed along the longitudinal direction, the plural detection object portions having a conductivity;
plural relative displacement detection parts for detecting a relative displacement of the moving body, the plural relative displacement detection parts being arranged along a moving direction of the moving body, the plural relative displacement detection parts being disposed so as to be capable of facing the respective detection object portions of the moving body with a predetermined interval therebetween; and
a position calculation part for calculating a displacement of the moving body by processing output signals from the relative displacement detection parts,
each of the relative displacement detection parts including a winding coil for forming an LC circuit and a capacitor connected between opposite end portions of the winding coil.

In the position detection apparatus according to this aspect (first aspect), a displacement of the moving body is detected as follows. If the moving body is moved, each of the relative displacement detection parts with the LC circuits has its oscillation frequency varying in the shape of a sinusoidal wave, and this oscillation frequency is acquired by the position calculation part. Then, in the position calculation part, a displacement of the moving body is calculated based on a correlation between the variation in each oscillation frequency and the displacement of the moving body.

At this time, the variations in the oscillation frequencies extracted from the respective relative displacement detection parts depict sinusoidal waves that are phase-shifted from one another, because the relative displacement detection parts are arranged along the moving direction of the moving body. In each of the sinusoidal waves, a change in oscillation frequency in proportion to a change in position of the moving body is small at and near the upper limit peak and the lower limit peak of the sinusoidal wave. If, therefore, the change in position of the moving body is calculated based on the change in oscillation frequency at and near the peaks, the change in position of the moving body cannot be detected with a high accuracy (with a high resolution).

In the remaining sections (hereinafter, peak-to-peak sections) excluding the peaks and their vicinities, the change in oscillation frequency in proportion to the change in position of the moving body is large, and therefore based on the change in oscillation frequency in the peak-to-peak sections, the change in position of the moving body can be detected with a high accuracy (with a high resolution). Thus, in the position detection apparatus according to the present teaching, detecting the change in position of the moving body with a high accuracy (with a high resolution) is enabled by selectively using a change in oscillation frequency corresponding to the peak-to-peak section excluding the peak and its vicinity of the phase-shifted sinusoidal waves in the relative displacement detection parts. Accordingly, the position detection apparatus according to the present teaching is capable of detecting a change in position of the moving body with a high accuracy (with a high resolution).

In the position detection apparatus according to the first aspect, an aspect (second aspect) may be adopted further including
an absolute position detection part for detecting an absolute position of the moving body, the absolute position detection part being disposed on one or the other side of the relative displacement detection parts in the moving direction of the moving body, the absolute position detection part being disposed so as to be capable of facing the respective detection object portions of the moving body with the predetermined interval therebetween, wherein
the absolute position detection part includes a winding coil for forming an LC circuit and a capacitor connected between opposite end portions of the winding coil, the winding coil having a length longer than that of each of the winding coils of the relative displacement detection parts, and
the position calculation part is configured to detect a position of the moving body by processing output signals from the relative displacement detection parts and the absolute position detection part.

This position detection apparatus is provided with the absolute position detection part including the winding coil longer than the winding coils of the relative displacement detection parts, and thus detecting a movement of the moving body over a long distance is enabled by the absolute position detection part. Accordingly, by using the absolute position detection part in combination with the relative displacement detection parts, the position calculation part is able to detect a rough absolute position of the moving body based on the oscillation frequency of the absolute position detection part, and in addition, is able to detect a high-accuracy (high-resolution) displacement (increment position) of the moving body based on changes in oscillation frequencies of the relative displacement detection parts. Consequently, the position calculation part is capable of detecting the absolute position of the moving body with a high accuracy (with a high resolution).

In the position detection apparatus according to the first aspect or the second aspect, an aspect may be adopted in which
the number of the relative displacement detection parts provided is n, the winding coils of the n relative displacement detection parts have the same length, and provided that the length is L, the winding coils are arranged at an interval of (L±L/n) from one another, and
each of the detection object portions of the moving body has a width in the longitudinal direction equal to the length of each of the winding coils of the relative displacement detection parts, and the detection object portions of the moving body are arranged at a distance from one another, the distance corresponding to the length of each of the winding coils of the relative displacement detection parts.

In the position detection apparatus according to any of the first to third aspects, an aspect (fourth aspect) may be adopted in which
each of the winding coils is shaped like a hollow cylinder, and
the moving body has a shaft-like shape, with the detection object portions having cylindrical shapes, and the moving body is disposed so as to be capable of being inserted into the respective winding coils.

In the position detection apparatus according to any of the first to third aspects, an aspect (fifth aspect) may be adopted in which
each of the winding coils is a planar coil.

The present teaching is also directed to a position detection apparatus including:
a moving body having an elongated shape, the moving body being disposed so as to be movable in its longitudinal direction, the moving body having plural detection object portions disposed along the longitudinal direction, the plural detection object portions having a conductivity;
plural relative displacement detection parts for detecting a relative displacement of the moving body, the plural relative displacement detection parts being disposed so as to be capable of facing the respective detection object portions of the moving body with a predetermined interval therebetween, the plural relative displacement detection parts being arranged side by side in a direction perpendicular to a moving direction of the moving body, the plural relative displacement detection parts being arranged one farther in forward direction than another in the moving direction; and
a position calculation part for calculating a displacement of the moving body by processing output signals from the relative displacement detection parts,
each of the relative displacement detection parts including a winding coil and a capacitor, the winding coil being a planar coil for forming an LC circuit, the capacitor being connected between opposite end portions of the winding coil.

In the position detection apparatus according to this aspect (sixth aspect), like in the position detection apparatus according to the first aspect, a displacement of the moving body is detected as follows. If the moving body is moved, each of the relative displacement detection parts with the LC circuits has its oscillation frequency varying in the shape of a sinusoidal wave, and this oscillation frequency is acquired by the position calculation part. Then, in the position calculation part, a displacement of the moving body is calculated based on a correlation between the variation in each oscillation frequency and the displacement of the moving body.

At this time, the variations in the oscillation frequencies extracted from the respective relative displacement detection parts depict sinusoidal waves that are phase-shifted from one another, because the relative displacement detection parts are arranged one farther in the forward direction than another in the moving direction of the moving body. In each of the sinusoidal waves, a change in oscillation frequency in proportion to a change in position of the moving body is small at and near the upper limit peak and the lower limit peak of the sinusoidal wave. If, therefore, the change in position of the moving body is calculated based on the change in oscillation frequency at and near the peaks, the change in position of the moving body cannot be detected with a high accuracy (with a high resolution).

In the peak-to-peak sections excluding the peaks and their vicinities, the change in oscillation frequency in proportion to the change in position of the moving body is large, and therefore based on the change in oscillation frequency in the peak-to-peak sections, the change in position of the moving body can be detected with a high accuracy (with a high resolution). Thus, in the position detection apparatus according to the present teaching, detecting the change in position of the moving body with a high accuracy (with a high resolution) is enabled by selectively using a change in oscillation frequency corresponding to the peak-to-peak section excluding the peak and its vicinity of the phase-shifted sinusoidal waves in the relative displacement detection parts. Accordingly, the position detection apparatus according to the present teaching is capable of detecting a change in position of the moving body with a high accuracy (with a high resolution).

In the position detection apparatus according to the sixth aspect, an aspect (seventh aspect) may be adopted further including
an absolute position detection part disposed on one or the other side of the relative displacement detection parts in the moving direction of the moving body, the absolute position detection part being disposed so as to be capable of facing the respective detection object portions of the moving body with the predetermined interval therebetween, wherein
the absolute position detection part includes a winding coil and a capacitor, the winding coil being a planar coil for forming an LC circuit, the capacitor being connected between opposite end portions of the winding coil, the winding coil of the absolute position detection part having a length longer than that of each of the winding coils of the relative displacement detection parts, and
the position calculation part is configured to detect a displacement of the moving body by processing output signals from the relative displacement detection parts and the absolute position detection part.

This position detection apparatus, like the position detection apparatus according to the second aspect, is provided with the absolute position detection part including the winding coil having a length longer than that of each of the winding coils of the relative displacement detection parts, and thus detecting a movement of the moving body over a long distance is enabled by the absolute position detection part. Accordingly, by using the absolute position detection part in combination with the relative displacement detection parts, the position calculation part is able to detect a rough absolute position of the moving body based on a change in oscillation frequency of the absolute position detection part, and in addition, is able to detect a high-accuracy (high-resolution) displacement (increment position) of the moving body based on changes in oscillation frequencies of the relative displacement detection parts. Consequently, the position calculation part is capable of detecting the absolute position of the moving body with a high accuracy (with a high resolution).

In the position detection apparatus according to the sixth aspect or the seventh aspect, an aspect (eighth aspect) may be adopted in which
the number of the relative displacement detection parts provided is n, the winding coils of the n relative displacement detection parts have the same length, and provided that the length is L, the winding coils are arranged one farther in the forward direction than another in the moving direction at a distance corresponding to (L±L/n) from one another, and
each of the detection object portions of the moving body has a width in the longitudinal direction equal to the length of each of the winding coils of the relative displacement detection parts.

### Advantageous Effects of Invention

In the present teaching, detecting a change in position of the moving body with a high accuracy (with a high resolution) is enabled by selectively using a change in oscillation frequency corresponding to the peak-to-peak section excluding the peak and its vicinity of the phase-shifted sinusoidal waves in the relative displacement detection parts.

Furthermore, since the absolute position detection part including the winding coil longer than the winding coils of the relative displacement detection parts are provided, detecting a movement of the moving body over a long distance is enabled by the absolute position detection part. By using the absolute position detection part in combination with the relative displacement detection parts, the position calculation part is able to detect the absolute position of the moving body based on a change in oscillation frequency of the absolute position detection part, and in addition, is able to detect a high-accuracy (high-resolution) displacement (increment position) of the moving body based on changes in oscillation frequencies of the relative displacement detection parts. Consequently, the position calculation part is capable of detecting the absolute position of the moving body with a high accuracy (with a high resolution).

### BRIEF DESCRIPTION OF DRAWINGS

FIG. 1 A perspective view showing a position detection apparatus according to an embodiment of the present teaching

FIG. 2 A front view showing the position detection apparatus according to the embodiment

FIG. 3 A right side view showing the position detection apparatus according to the embodiment

FIG. 4 An explanatory diagram corresponding to a plan view showing, partially in the form of a block diagram, a schematic configuration of a measurement unit according to the embodiment

FIG. 5 (a) is a left side view of a moving body shown in FIG. 4; and (b) is a side view of winding coils, which form a first detection part, a second detection part, and a third detection part, respectively, shown in FIG. 4.

FIG. 6 A graph showing an oscillation frequency relative to the positional relationship between the moving body and the winding coil

FIG. 7 A graph showing the oscillation frequency relative to the positional relationship between the moving body and the winding coil

FIG. 8 A graph showing the oscillation frequency relative to the positional relationship between the moving body and the winding coil

FIG. 9 A graph showing the oscillation frequency relative to the positional relationship between the moving body and the winding coil

FIG. 10 A data table containing data stored in a data storage part according to the embodiment, the data table concerning the relationship between a position of the moving body and the oscillation frequency obtained from each winding coil

FIG. 11 An explanatory diagram showing a variation of the detection part according to the embodiment

FIG. 12 An explanatory diagram showing a variation of the positional arrangement relationship between the moving body and the winding coils

FIG. 13 An explanatory diagram showing a variation of the moving body

FIG. 14 An explanatory diagram showing a variation of the moving body

FIG. 15 An explanatory diagram corresponding to a plan view showing a variation of the moving body and the winding coils

FIG. 16 A front view of the moving body and the winding coils shown in FIG. 15

FIG. 17 An explanatory diagram corresponding to a bottom view showing still another variation of the moving body applicable to the variation shown in FIG. 15

FIG. 18 An explanatory diagram corresponding to plan views showing still another variations concerning the arrangement of a first detection part, a second detection part, and a third detection part of the variation shown in FIG. 15

### DESCRIPTION OF EMBODIMENTS

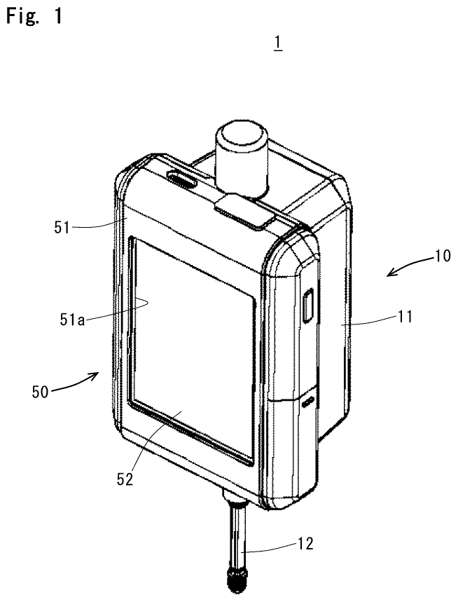

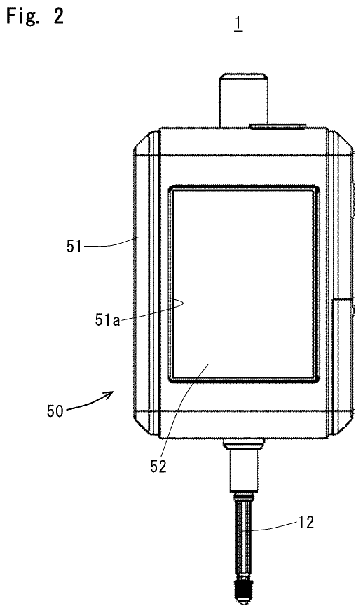

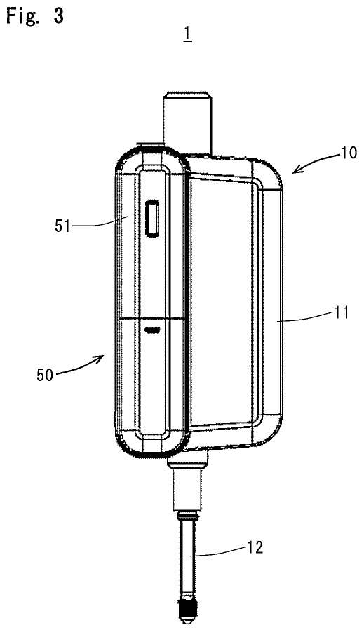

In the following, a specific embodiment of the present teaching will be described with reference to the drawings. As shown in FIG. 1 to FIG. 3, a position detection apparatus 1 according to this example is composed of a measurement unit 10 and a display unit 50, which are unitedly coupled to each other.

The display unit 50 includes a box-shaped case 51, a display control part (not shown) stored in the case 51, and a liquid crystal panel 52 stored in the case 51 while being exposed to the outside through an opening 51a of the case 51, the liquid crystal panel 52 being connected to the display control part (not shown). The liquid crystal panel 52, under control by the display control part (not shown), displays a measured value obtained as a result of a measurement performed by the measurement unit 10.

The measurement unit 10 includes a case 11, a probe 12, a moving body 13, first and second detection parts 20, 25 serving as relative displacement detection parts, a third detection part 30 serving as an absolute position detection part, an oscillation control and frequency conversion part 40, a position calculation part 41, a data storage part 42, and the like (see FIG. 1 to FIG. 4).

The case 11 has a box-like shape, and is coupled to the case 51. The probe 12 has a shaft-like shape, with one end thereof extending outward from a lower surface of the case 11 and the other end thereof being positioned in the case 11. The probe 12 is held by the case 11 so as to be capable of advancing and retracting in the direction along its axis while being biased in the advancing direction.

The moving body 13, the first detection part 20, the second detection part 25, the third detection part 30, the oscillation control and frequency conversion part 40, the position calculation part 41, and the data storage part 42 are each disposed in the case 11. The moving body 13 includes a shaft portion 14 and plural (in this example, four) detection object portions 15a, 15b, 15c, 15d. The shaft portion 14 is coupled to the probe 12 so as to be coaxial with the probe 12. The plural detection object portions 15a, 15b, 15c, 15d are fitted to the exterior of the shaft portion 14.

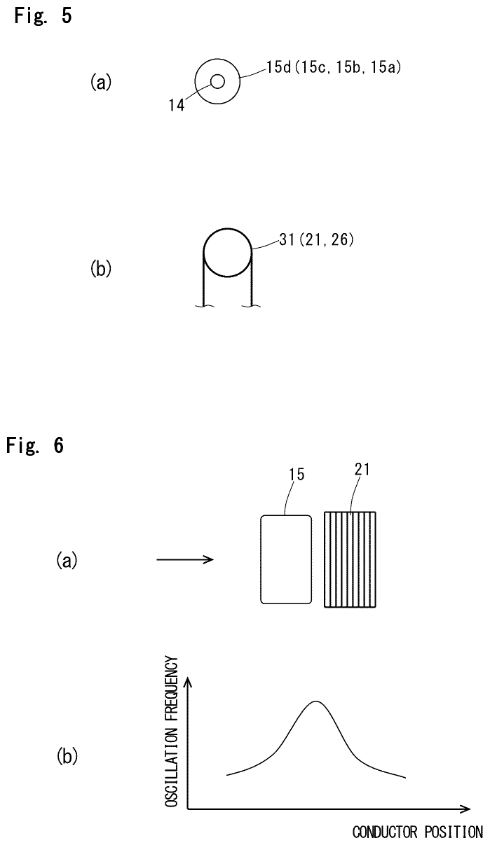

Referring to FIG. 5(a), the shaft portion 14 is shaped like a solid cylinder. The detection object portions 15a, 15b, 15c, and 15d are shaped like hollow cylinders, and are at predetermined equal intervals fitted to the exterior of the shaft portion 14. No limitation is put on a material of the shaft portion 14, but from the viewpoint of achievement of a high measurement accuracy, stainless steel is one preferable example. As for a material of the detection object portions 15a, 15b, 15c, 15d, there is no limitation except that they are required to have a conductivity, but one preferable example of the material can be copper or aluminum. Although this example illustrates an example case where four detection object portions 15a, 15b, 15c, 15d are disposed, this is not limiting, and the number of detection object portions may be not more than three (and not less than one), or may be not less than five.

The first detection part 20 includes a first coil 21, which is a winding coil, and a capacitor 22 connected between opposite end portions 21a and 21b of the first coil 21. The second detection part 25, likewise, includes a second coil 26, which is a winding coil, and a capacitor 27 connected between opposite end portions 26a and 26b of the second coil 26. The third detection part 30, likewise, includes a third coil 31, which is a winding coil, and a capacitor 32 connected between opposite end portions 31a and 31b of the third coil 31. The first detection part 20, the second detection part 25, and the third detection part 30 are LC circuits including the first coil 21, the second coil 26, and the third coil 31, respectively, and the capacitors 22, 27, and 32, respectively. The first detection part 20, the second detection part 25, and the third detection part 30 electrically oscillate due to inductance components of the first coil 21, the second coil 26, and the third coil 31 and capacitance components of the capacitors 22, 27, and 32.

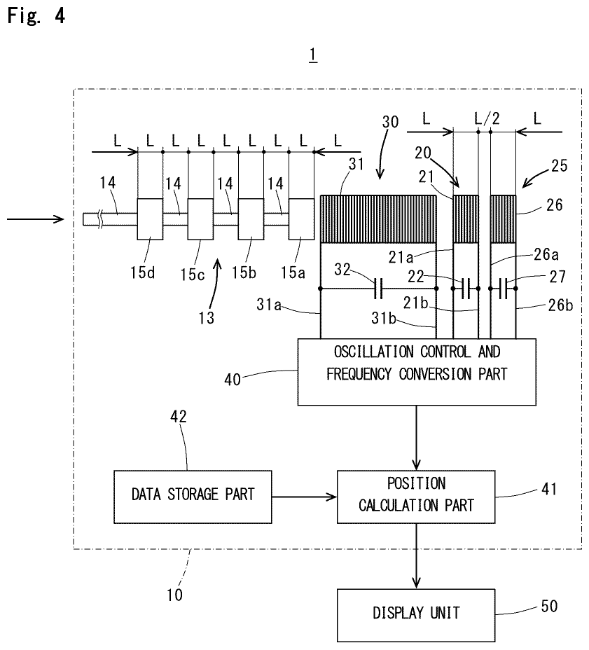

Referring to FIG. 5(b), the first coil 21, the second coil 26, and the third coil 31, which are shaped like hollow cylinders, are arranged in a mutually coaxial positional relationship, and are also arranged so as to be coaxial with the moving body 13, too, as shown in FIG. 4. The first coil 21 and the second coil 26 have equal coil lengths (widths of the coils), the length L, and are at a distance (interval) of L/2 from one another. Here, the coil length of the third coil 31 is set in accordance with the length measurement performance (the length that is able to be measured) of the position detection apparatus 1. In this example, the third coil 31 is arranged closest to the moving body 13, and the first coil 21 and the second coil 26 are arranged second and third closest, respectively. The interval between the third coil 31 and the first coil 21 is set at an appropriate interval based on the measurement accuracy. In other words, the third coil 31 and the first coil 21 are conductors, which are influenced from each other if disposed too close to each other. Thus, they are disposed with such a distance that the influence can be small.

The width dimension of the detection object portions 15a, 15b, 15c, 15d of the moving body 13 in their axial direction is set at a dimension L, which is equal to the coil length of the first coil 21 and the second coil 26. The interval of the detection object portions 15a, 15b, 15c, 15d is also set at the dimension L, which is equal to the coil length. The outer diameter of the detection object portions 15a, 15b, 15c, 15d is set at the largest possible diameter that allows the detection object portions 15a, 15b, 15c, 15d to pass through the insides of the first coil 21, the second coil 26, and the third coil 31 without contacting the first coil 21, the second coil 26, and the third coil 31.

The oscillation control and frequency conversion part 40, which is constituted by an electrical and electronic circuit, is a device to which the opposite end portions 21a, 21b of the first coil 21, the opposite end portions 26a, 26b of the second coil 26, and the opposite end portions 31a, 31b of the third coil 31 are connected so that the oscillation control and frequency conversion part 40 controls oscillations of the first detection part 20, the second detection part 25, and the third detection part 30, and converts an oscillation frequency of each LC circuit into a digital value and outputs the digital value.

Referring to FIG. 6(a), for example, if the detection object portion 15a, which is a conductor, is moved in the direction indicated by the arrow to pass through the inside of the first coil 21, the oscillation frequency of the LC circuit constituted by the first coil 21 changes as shown in FIG. 6(b). In FIG. 6(b), the conductor position is a relative positional relationship between the detection object portion 15a and the first coil 21. As the detection object portion 15a enters the first coil 21, the oscillation frequency of the LC circuit increases, and while the detection object portion 15a overlaps the first coil 21, the oscillation frequency reaches its maximum (peak). As the detection object portion 15a gets out of the first coil 21, the oscillation frequency of the LC circuit decreases. Thus, the oscillation frequency of the LC circuit depicts a sinusoidal wave that changes in accordance with the relative positional relationship between the detection object portion 15a and the first coil 21.

The oscillation control and frequency conversion part 40 detects the oscillation frequency in the first detection part 20, the oscillation frequency in the second detection part 25, and the oscillation frequency in the third detection part 30, the oscillation frequencies changing in accordance with the positional relationships relative to the detection object portions 15a, 15b, 15c, 15d. The oscillation control and frequency conversion part 40 outputs these oscillation frequencies in the form of digital values. This detection of the oscillation frequency by the oscillation control and frequency conversion part 40 is carried out at every predetermined sampling interval.

Here, as can be seen from FIG. 6, in such a sinusoidal wave, a change (Δf) in oscillation frequency in proportion to a change (ΔD) in relative position between the detection object portion 15a and the first coil 21 is small at and near the upper limit peak and the lower limit peak of the sinusoidal wave. It is therefore difficult to detect the change (ΔD) in position with a high accuracy (with a high resolution) based on the change (Δf) in oscillation frequency at and near the peaks. Put it the other way around, in a section excluding the peaks and their vicinities, that is, in a section (peak-to-peak section) between a peak and its vicinity and another peak and its vicinity, the slope is steep, and the change (Δf) in oscillation frequency in proportion to the change (ΔD) in position is large, which makes it possible to detect the change (ΔD) in position with a high accuracy (with a high resolution) based on the change (Δf) in oscillation frequency.

In a configuration adopted in this example, therefore, the moving body 13 is provided with the plural detection object portions 15a, 15b, 15c, 15d, while the third detection part 30, the first detection part 20, and the second detection part 25 are arranged in a moving path of the moving body 13. Here, the third detection part 30 is for detecting the position of the moving body 13 in the set moving path, as an absolute position. The first detection part 20 and the second detection part 25 are for detecting the position of the moving body 13 as an increment position (relative position).

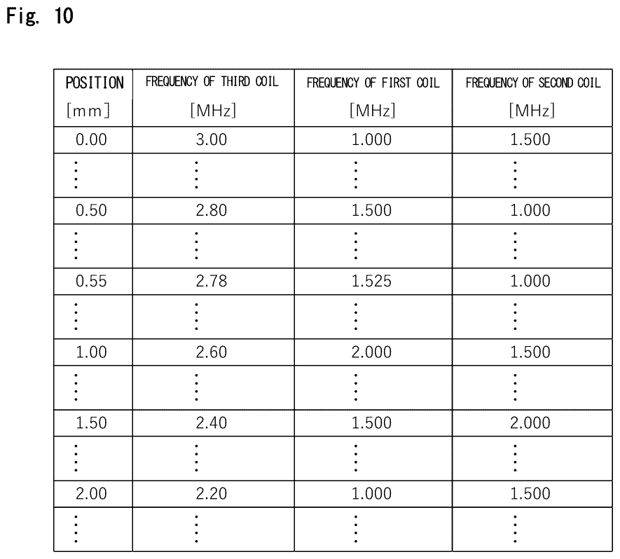

The position calculation part 41: calculates the position of the moving body 13 in the axial direction based on data stored in the data storage part 42 and oscillation frequencies that are outputted from the first detection part 20, the second detection part 25, and the third detection part 30 at every predetermined sampling interval; and outputs position data obtained by the calculation to the display unit 50. The display unit 50, under control by the display control part (not shown), causes the position data received from the position calculation part 41 to be displayed on the liquid crystal panel 52. In the data storage part 42, a data table illustrated in FIG. 10 is prestored.

Next, the principle of the position detection in this example will be described.

### Principle of Position Detection

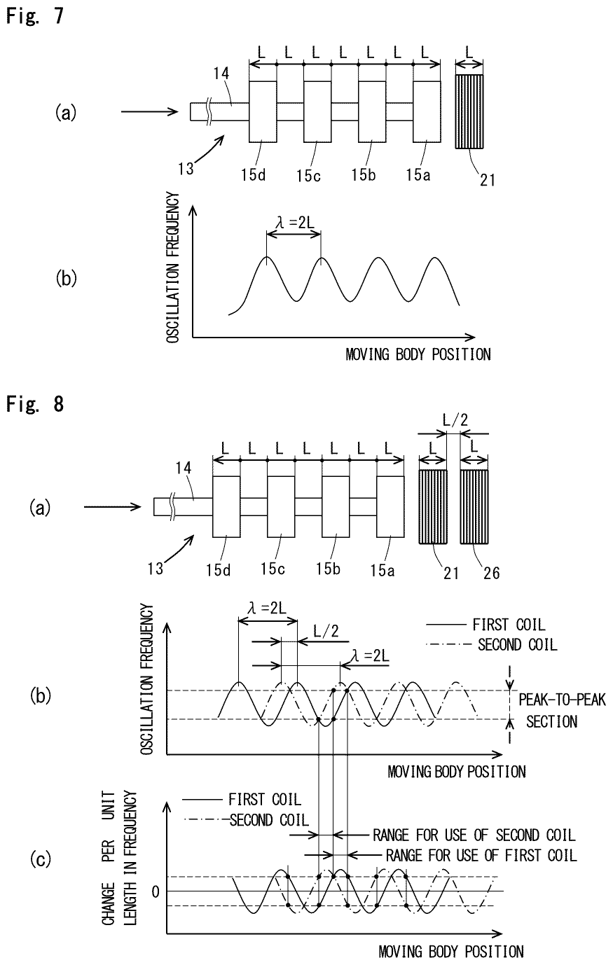

Referring to FIG. 7(a), if the moving body 13 is moved in its axial direction, which is the direction indicated by the arrow, to pass through the inside of the first coil 21 of the first detection part 20, the oscillation frequency of the LC circuit extracted from the first coil 21 changes as shown in FIG. 7(b). To be specific, the oscillation frequency depicts a sinusoidal wave whose wavelength λ is 2L, in which the upper limit peak value is exhibited at positions where the detection object portions 15a, 15b, 15c, 15d overlap the first coil 21, and the lower limit peak value is exhibited at positions where the detection object portions 15a, 15b, 15c, 15d do not overlap the first coil 21.

Referring to FIG. 8, the second coil 26 of the second detection part 25 is arranged downstream of the first coil 21 of the first detection part 20 with an interval of L/2 therebetween in a moving direction (which is a displacing direction, or the direction indicated by the arrow) of the moving body 13. If, in this state, the moving body 13 is moved along its axis in the direction indicated by the arrow to pass through the inside of the first coil 21 of the first detection part 20 and the inside of the second coil 26 of the second detection part 25, the oscillation frequency of the LC circuit extracted from the first coil 21 changes in a sinusoidal wave as illustrated with the solid line in FIG. 8(b), and likewise, the oscillation frequency of the LC circuit extracted from the second coil 26 changes in a sinusoidal wave as illustrated with the dashed-and-dotted line in FIG. 8(b).

As can be seen from FIG. 8(b), the change in oscillation frequency of the first coil 21 is phase-advanced by λ/4(=L/2) as compared to the change in oscillation frequency of the second coil 26. Thus, a changing waveform (sinusoidal wave) of the oscillation frequency of the first coil 21 and a changing waveform (sinusoidal wave) of the oscillation frequency of the second coil 26 are in such a state that the peak and its vicinity of one of the waveforms overlap the peak-to-peak section of the other of the waveforms in the moving direction of the moving body 13. In this example, the aim is to have a phase difference of ±λ/4, and therefore it may be acceptable that the interval between the first coil 21 and the second coil 26 is set to 3L/2.

As described above, at and near an upper limit peak and a lower limit peak of a sinusoidal wave, it is difficult to detect a change (ΔD) in position with a high accuracy (with a high resolution) based on a change (Δf) in oscillation frequency. Put it the other way around, in a section (peak-to-peak) between a peak and its vicinity and another peak and its vicinity, it is possible to detect a change (ΔD) in position with a high accuracy (with a high resolution) based on a change (Δf) in oscillation frequency. FIG. 8(c) shows a change (Δf) per unit length in oscillation frequency of the first coil 21 shown in FIG. 8(b), and a change (Δf) per unit length in oscillation frequency of the second coil 26 shown in FIG. 8(b). The graph of FIG. 8(c) is obtained as a result of the graph shown in FIG. 8(b) subjected to differentiation processing.

In the waveforms shown in FIG. 8(c), portions above the upper dashed line and portions below the lower dashed line are ranges where the change (Δf) in frequency is large. These regions are regions corresponding to the peak-to-peak sections of the waveforms shown in FIG. 8(b), and are regions where the change (ΔD) in position can be detected with a high accuracy (with a high resolution) based on the change (Δf) in oscillation frequency. Portions of the waveforms of the respective oscillation frequencies located in the peak-to-peak sections are continuous in the moving direction of the moving body 13. Accordingly, detecting the position of the moving body 13 with a high accuracy is enabled by selectively using, from among the oscillation frequency extracted from the first coil 21 and the oscillation frequency extracted from the second coil 26, an oscillation frequency whose changing waveform corresponds to the peak-to-peak section. To facilitate the understanding of this point, an example of a used region in the oscillation frequency of the first coil 21 and an example of a used region in the oscillation frequency of the second coil 26 are shown in FIG. 8(b) and FIG. 8(c). In this example, only about 70% or more of the peak of Δf is used.

Using the oscillation frequencies extracted from the first coil 21 and the second coil 26 makes it possible to detect how far the moving body 13 has displaced from a certain position. That is, a displacement of the moving body 13 as an increment value (relative value) can be detected.

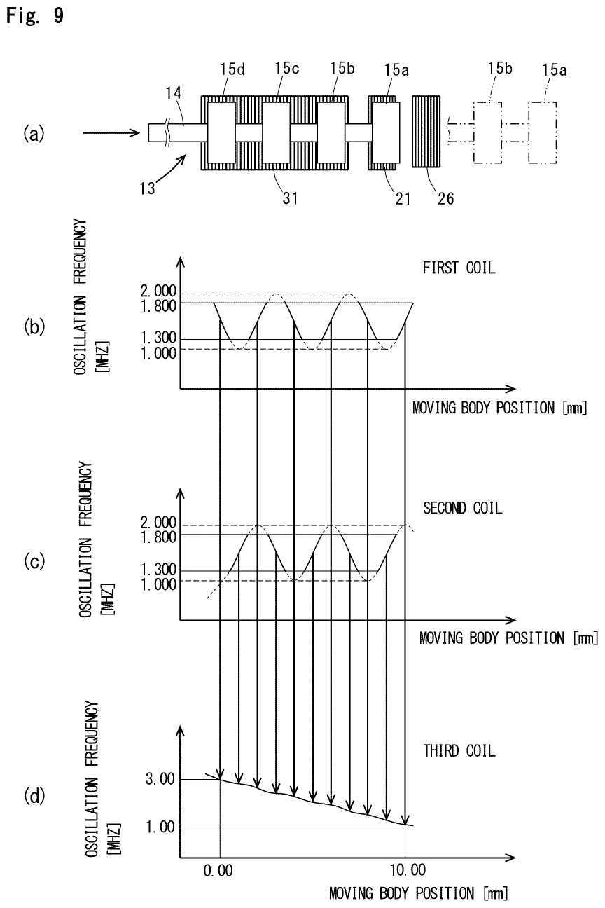

Referring to FIG. 9, the third coil 31 of the third detection part 30 is arranged upstream of the first coil 21 of the first detection part 20 with a predetermined interval therebetween in the moving direction of the moving body 13. If, in this state, the moving body 13 is moved along its axis in the direction indicated by the arrow to pass through the inside of the third coil 31 of the third detection part 30, the inside of the first coil 21 of the first detection part 20, and the inside of the second coil 26 of the second detection part 25; the oscillation frequency of the LC circuit extracted from the first coil 21 changes in a sinusoidal wave as illustrated in FIG. 9(b), the oscillation frequency of the LC circuit extracted from the second coil 26 changes in a sinusoidal wave as illustrated in FIG. 9(c), and the oscillation frequency of the LC circuit extracted from the third coil 31 changes as illustrated in FIG. 9(d).

While the moving body 13 is passing through the third coil 31 of the third detection part 30, the oscillation frequency of the LC circuit extracted from the third coil 31 is at its peak when the rear three of the detection object portions in the moving direction, namely, the detection object portions 15b, 15c, 15d, are within the third coil 31. As shown in FIG. 9(d), along with passing of the detection object portions 15b, 15c, and 15d sequentially, a vibration frequency is gradually lowered, and as a whole, changes almost linearly. Since a change (Δf) in oscillation frequency in proportion to a change (ΔD) in relative position between the moving body 13 and the third coil 31 is small, it is difficult to detect a change (ΔD) in position with a high accuracy (with a high resolution) based on a change (Δf) in oscillation frequency, but it is possible to detect a rough absolute position of the moving body 13 based on the oscillation frequency extracted from the third coil 31.

As thus far described, in the example shown in FIG. 9, the rough absolute position (low-resolution position) of the moving body 13 can be detected based on the oscillation frequency extracted from the third coil 31, while the high-accuracy displacement (high-resolution displacement) as the increment value (relative value) of the moving body 13 can be detected based on the oscillation frequencies extracted from the first coil 21 and the second coil 26. Accordingly, it is possible to detect the absolute position of the moving body 13 with a high accuracy, by using both the oscillation frequency extracted from the third coil 31 and the oscillation frequencies extracted from the first and second coils 21, 26.

To facilitate the understanding, the example shown in FIG. 9 illustrates the relationship between the oscillation frequencies extracted from the first, second, and third coils 21, 26, 31 and a specific position of the moving body 13. It should be noted that this illustration is just an example for explanation purposes, and does not make sure that it is reproduced in a specific example.

Referring to FIG. 9(b) and FIG. 9(c), the oscillation frequencies extracted from the first coil 21 and the second coil 26 have a maximum value of 2.000 MHz and a minimum value of 1.000 MHz, and a range (peak-to-peak range) available for a high resolution is a range of 1.300 MHz to 1.800 MHz. The displacement of the moving body 13 corresponding to this is L/2. Suppose L=2 mm, the displacement that can be detected as a high resolution is 1 mm. Referring to FIG. 9(d), the oscillation frequency extracted from the third coil 31 has a maximum value of 3.00 MHz and a minimum value of 1.00 MHz. When the oscillation frequency is 3.00 MHz, the displacement of the moving body 13 is 0 mm, and when the oscillation frequency is 1.00 MHz, the displacement of the moving body 13 is 10 mm.

The relationship of the displacement of the moving body 13 with the oscillation frequencies extracted from the first, second, and third coils 21, 26, 31, respectively, has been obtained in advance by calibration, and this correlation is, in the form of a data table, stored in the data storage part 42. In calibration, for example, each of the oscillation frequencies can be obtained with the displacement of the moving body 13 being set on a 1-μm unit basis. This is not limiting, however. An exemplary data table is shown in FIG. 10. In FIG. 10, the position is at intervals of 0.001 mm(=1 μm).

The position calculation part 41 acquires, from the oscillation control and frequency conversion part 40, the oscillation frequencies extracted from the first, second, and third coils 21, 26, 31, respectively, and calculates the displacement (position) of the moving body 13 with reference to the data table stored in the data storage part 42. For example in a case where the third coil 31 has an oscillation frequency of 2.78 MHz, the position calculation part 41 refers to the data table stored in the data storage part 42, and estimates that the position of the moving body 13 corresponding to this oscillation frequency of 2.78 MHz is a position of 0.55 mm(=550 μm), for example. Then, the position calculation part 41 refers to the oscillation frequencies of the first coil 21 and the second coil 26, and adopts one of the oscillation frequencies that is within a range of 1.3 MHz to 1.8 MHz.

For example, if, at this time, the first coil 21 has an oscillation frequency of 1.530 MHz while the second coil 26 has an oscillation frequency of 1.005 MHz, the position calculation part 41 adopts 1.530 MHz, which is the oscillation frequency of the first coil 21, and calculates the displacement of the moving body 13 by using 1.530 MHz. More specifically, by using as a reference 0.55 mm(=550 μm), which is the position of the moving body 13 calculated from the oscillation frequency (2.78 MHz) of the third coil 31, the position calculation part 41 calculates a positional shift (displacement) from this position, and sets it as the position of the moving body 13. Since the oscillation frequency of the first coil 21 at the reference position is 1.525 MHz, the position calculation part 41 calculates by interpolation processing a quantity of displacement at a time when the oscillation frequency of the first coil 21 is 1.530 MHz. Referring to FIG. 9(b), the relationship between the change Δf in oscillation frequency and the displacement ΔD is ΔD/Δf=1 mm/0.5 MHz=2 mm/MHz. Since Δf is 0.005 MHz, the positional shift (displacement) ΔD=2000 μm×0.005 MHz=10 μm. Considering above, the position (displacement as the absolute quantity) of the moving body 13 is 0.55+0.01=0.56 mm(=560 μm).

In the exemplary data table shown in FIG. 10, the position of the moving body 13 is on a 10-μm unit basis, and the correlation of the position of the moving body 13 with the oscillation frequencies of the first, second, and third coils 21, 26, 31 is represented. This is not limiting, however. The position of the moving body 13 may be on the basis of a unit greater than 10 μm, or may be on the basis of a unit smaller than 10 μm. In a case of a greater unit, it is possible that the absolute position of the moving body 13 calculated from the oscillation frequency of the third coil 31 is calculated on a small unit basis by interpolation processing. As for the quantity of displacement from the reference position of the moving body 13 calculated from the oscillation frequency of the third coil 31, too, a displacement can be calculated with a higher resolution by interpolation processing using the oscillation frequencies of the first coil 21 and the second coil 26.

As thus far described, the position detection apparatus 1 according to this example is capable of detecting the rough absolute position (low-resolution position) of the moving body 13 based on the oscillation frequency extracted from the third coil 31, and is capable of detecting a high-accuracy displacement (high-resolution displacement) as the increment value (relative value) of the moving body 13 based on the oscillation frequencies extracted from the first coil 21 and the second coil 26. Accordingly, it is possible to detect the absolute position of the moving body 13 with a high accuracy, by using both the oscillation frequency extracted from the third coil 31 and the oscillation frequencies extracted from the first and second coils 21, 26.

A specific embodiment of the present teaching has been described so far. Specific aspects that the present teaching can adopt are never limited to the aspect shown in the foregoing example.

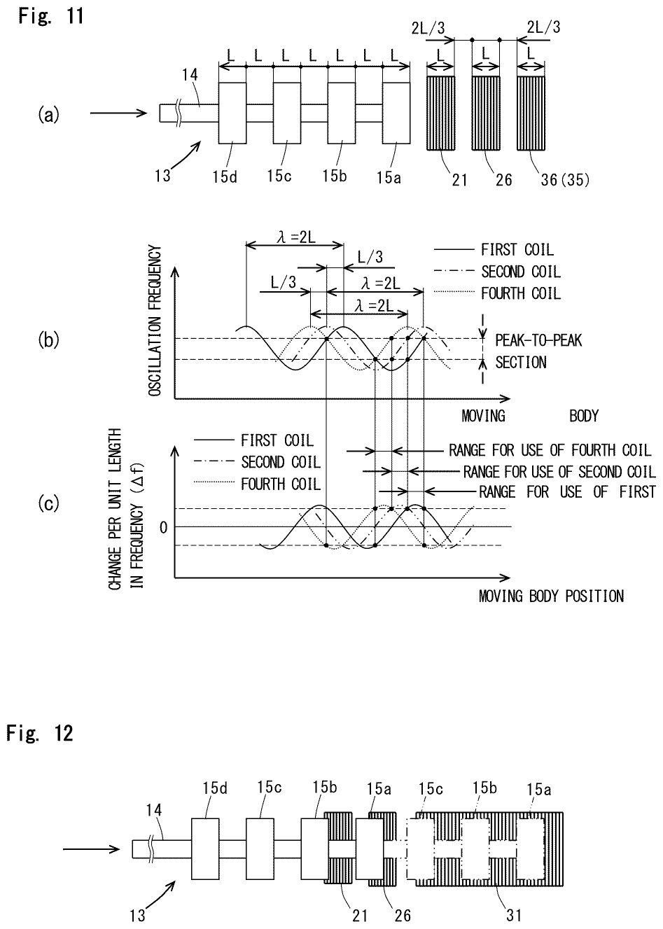

For example, the foregoing example provides two relative displacement detection parts, namely, the first detection part 20 and the second detection part 25, as the relative displacement detection parts for detecting the increment value (relative value) of the displacement of the moving body 13; however, the number of relative displacement detection parts that can be provided is not limited to two, and it may be acceptable that three or more relative displacement detection parts are provided. An example of such cases is illustrated in FIG. 11, which provides three relative displacement detection parts.

The example shown in FIG. 11(a) corresponds to the position detection apparatus 1 shown in FIG. 4 additionally provided with a fourth detection part 35 as the relative displacement detection part. In this example, the interval between the first coil 21 and the second coil 26 is set to 2L/3. The fourth detection part 20, like the first detection part 20 and the second detection part 25, includes a fourth coil 36, which is a winding coil, and a capacitor (not shown) connected between opposite end portions of the fourth coil 36. The opposite end portions of the fourth coil 36 are connected to the oscillation control and frequency conversion part 40. In FIG. 11(a), illustration of the third coil 31 is omitted, though it is shown in FIG. 4 and FIG. 9.

The fourth coil 36, like the first coil 21 and the second coil 26, is shaped like a hollow cylinder, and is arranged so as to be coaxial with them. In addition, the fourth coil 36 is arranged more rightward than the second coil 26 with an interval of 2L/3 therebetween in the direction indicated by the arrow in FIG. 11. The coil length of the fourth coil 36 is the length L, which is equal to the coil length of the first coil 21 and the second coil 26. The interval of coils is set in accordance with the number of coils. When the number of coils provided is n, the interval is generalized to be (L±L/n).

In this example, as shown in FIG. 11(a), if the moving body 13 is moved along its axis in the direction indicated by the arrow to pass through the inside of the first coil 21 of the first detection part 20, the inside of the second coil 26 of the second detection part 25, and the inside of the fourth coil 36 of the fourth detection part 35; the oscillation frequency of the LC circuit extracted from the first coil 21 changes in a sinusoidal wave as illustrated with the solid line in FIG. 11(b), the oscillation frequency of the LC circuit extracted from the second coil 26 also changes in a sinusoidal wave as illustrated with the dashed-and-dotted line in FIG. 11(b), and the oscillation frequency of the LC circuit extracted from the fourth coil 36 also changes in a sinusoidal wave as illustrated with the dotted line in FIG. 11(b).

As can be seen from FIG. 11(b), the change in oscillation frequency of the second coil 26 is phase-advanced by λ/6(=L/3) as compared to the change in oscillation frequency of the fourth coil 36, and the change in oscillation frequency of the first coil 21 is phase-advanced by λ/6(=L/3) as compared to the change in oscillation frequency of the second coil 26.

FIG. 11(c) shows changes (Δf) per unit length in oscillation frequencies of the first, second, and fourth coils 21, 26, and 36 shown in FIG. 11(b), and in other words, FIG. 11(c) shows a result of the graph shown in FIG. 11(b) subjected to differentiation processing. In the waveforms shown in FIG. 11(c), portions above the upper dashed line and portions below the lower dashed line are ranges where the change (Δf) in frequency is large. These regions are regions corresponding to the peak-to-peak sections of the waveforms shown in FIG. 11(b), and are regions where the change (ΔD) in position can be detected with a high accuracy (with a high resolution) based on the change (Δf) in oscillation frequency. Portions of the waveforms of the respective oscillation frequencies located in the peak-to-peak sections are continuous in the moving direction of the moving body 13.

Accordingly, in this example, too, detecting the position of the moving body 13 with a high accuracy is enabled by selectively using, from among the oscillation frequency extracted from the first coil 21, the oscillation frequency extracted from the second coil 26, and the oscillation frequency extracted from the fourth coil 36, an oscillation frequency whose changing waveform corresponds to the peak-to-peak section. To facilitate the understanding of this, an example of a used region in the oscillation frequency of the first coil 21, an example of a used region in the oscillation frequency of the second coil 26, and an example of a used region in the oscillation frequency of the fourth coil 36 are shown in FIG. 11(b) and FIG. 11(c). In this example, only about 87% or more of the peak of Δf is used.

In the foregoing example, the third coil 31, the first coil 21, and the second coil 26 are coaxially arranged in this order from the upstream to the downstream in the moving direction (displacing direction) of the moving body 13; however, this aspect is not limiting, and in an exemplary aspect, the first coil 21, the second coil 26, and the third coil 31 may be arranged in this order from the upstream to the downstream as shown in FIG. 12. In this aspect, too, the position of the moving body 13 can be detected with a high accuracy. The same is true for the aspect shown in FIG. 11, in which three or more detection parts are provided.

In the position detection apparatus according to the aspect shown in FIG. 4, FIG. 11, or FIG. 12, to detect not the absolute position but only the increment position (relative displacement) of the moving body 13, the third detection part 30 need not be provided, and it suffices that only the first detection part 20 and the second detection part 25 are provided. In such an aspect, too, the increment position (relative displacement) of the moving body 13 can be detected with a high accuracy and a high resolution.

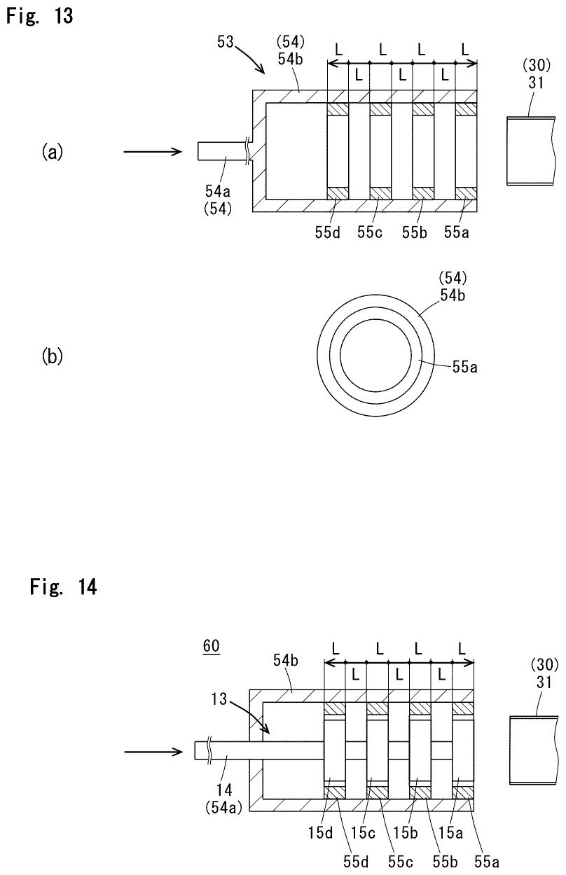

In the position detection apparatus, and the like, according to the aspect shown in FIG. 4, FIG. 11, or FIG. 12, the moving body 13 may adopt aspects shown in FIG. 13 and FIG. 14. FIG. 13 shows a moving body 53 as an alternative to the moving body 13. FIG. 13(a) is a front cross-sectional view of the moving body 13, and FIG. 13(b) is a right side view of (a).

Referring to FIG. 13(a), the moving body 53 includes a holder 54 and detection object portions 55a, 55b, 55c, 55d. The holder 54 includes a cylindrical body 54b and a shaft portion 54a. The cylindrical body 54b has a hollow, bottomed cylinder shape with its one end opened. The shaft portion 54a is disposed at the left-side end surface in the drawing (at an outer end surface of a bottom portion) of the cylindrical body 54b so as to extend out of it coaxially with the cylindrical body 54b. The detection object portions 55a, 55b, 55c, 55d are ring-shaped projections disposed at predetermined intervals on an inner circumferential surface of the cylindrical body 54b.

Similarly to the moving body 13, no limitation is put on materials of the shaft portion 54a and the cylindrical body 54b, but from the viewpoint of achievement of a high measurement accuracy, they are preferably made of stainless steel. As for a material of the detection object portions 55a, 55b, 55c, 55d, there is no limitation except that they are required to have a conductivity, but one preferable example of the material can be copper or aluminum. Although FIG. 13 illustrates an example case where four detection object portions 55a, 55b, 55c, 55d are disposed, this is not limiting, and the number of detection object portions may be not more than three (and not less than one), or may be not less than five.

Each of the detection object portions 55a, 55b, 55c, 55d is formed such that its width is a dimension L, which is equal to the coil length of the first coil 21 and the second coil 26. The interval of the detection object portions 55a, 55b, 55c, 55d is also the dimension L. The detection object portions 55a, 55b, 55c, 55d can be formed by fitting ring-shaped parts to the interior of the cylindrical body 54b through a driving-in process or alternatively can be formed by fitting a hollow and cylindrical element body to the interior of the cylindrical body 54b and then shaving it so as to form groove portions, which are to be recesses. The inner diameter of the detection object portions 55a, 55b, 55c, 55d is set at the smallest possible diameter as long as it allows the first, second, and third coils 21, 26, 31 to pass therethrough without contacting the detection object portions 55a, 55b, 55c, 55d.

If this moving body 53 is moved in the direction indicated by the arrow, the third coil 31, the first coil 21, and the second coil 26 pass through the insides of the detection object portions 55a, 55b, 55c, 55d in a relative sense, so that oscillation frequencies that depict sinusoidal waves are extracted from the respective coils 31, 21, and 26.

A moving body 60 shown in FIG. 14 is a moving body of a complex type, in which the above-described moving body 13 and moving body 53 are combined and mutually coupled. This example adopts an aspect in which the shaft portion 54a of the holder 54 is unified with the shaft portion 14 of the moving body 13, and the bottom portion of the cylindrical body 54b is penetrated by the shaft portion 14 so that the bottom portion is anchored to the shaft portion 14. The detection object portions 15a, 15b, 15c, 15d of the moving body 13 are disposed in the cylindrical body 54b of the moving body 53 such that the positions of the detection object portions 15a, 15b, 15c, 15d align with the detection object portions 55a, 55b, 55c, 55d, respectively. The interval between the detection object portions 15a, 15b, 15c, 15d and the detection object portions 55a, 55b, 55c, 55d is an interval that allows the third coil 31, the first coil 21, and the second coil 26 to pass through in a relative sense.

If this moving body 60 is moved in the direction indicated by the arrow, the third coil 31, the first coil 21, and the second coil 26 advance into the gap between the detection object portions 15a, 15b, 15c, 15d and the detection object portions 55a, 55b, 55c, 55d, and they pass by each other in a relative manner, so that oscillation frequencies that depict sinusoidal waves are extracted from the respective coils 31, 21, and 26. In this aspect, the third coil 31, the first coil 21, and the second coil 26 are sandwiched between the detection object portions 15a, 15b, 15c, 15d and the detection object portions 55a, 55b, 55c, 55d. This can provide larger changes in oscillation frequencies as sinusoidal waves extracted from the respective coils 31, 21, 26. Accordingly, the position detection with a higher accuracy can be obtained.

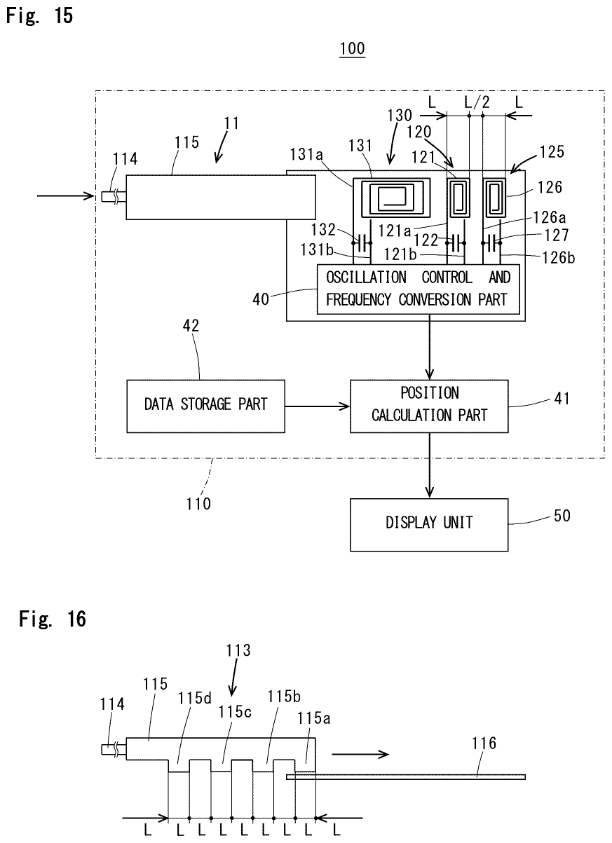

In the foregoing example, the first coil 21 of the first detection part 20, the second coil 26 of the second detection part 25, and the third coil 31 of the third detection part are in the shape of hollow cylinders; however, the shapes of the first, second, and third coils 21, 26, 31 are not limited to such hollow cylinders, and they may have planar shapes as illustrated in FIG. 15. The same is true for the aspect shown in FIG. 11, in which three or more detection parts are provided.

A position detection apparatus 100 shown in FIG. 15 is different from the above-described position detection apparatus 1, in terms of configurations of a first detection part 120, a second detection 125, a third detection part 130, and a moving body 113. In FIG. 15, therefore, parts having the same configurations as those of the position detection apparatus 1 are given the same corresponding reference signs.

Referring to FIG. 15, the position detection apparatus 100 includes a third coil 131, a first coil 121, and a second coil 126, which are formed with planar shapes on a substrate 116 and are arranged in a line along the direction indicated by the arrow, i.e., the moving direction of the moving body 113. In the position detection apparatus 100, the first detection part 120 includes the first coil 121 and a capacitor 122 connected between opposite end portions 121a and 121b of the first coil 121, and the second detection part 125 includes the second coil 126 and a capacitor 127 connected between opposite end portions 126a and 126b of the second coil 126. The third detection part 130 includes the third coil 131 and a capacitor 132 connected between opposite end portions 131a and 131b of the third coil 131.

The opposite end portions 121a, 121 of the first coil 121, the opposite end portions 126a, 126b of the second coil 126, and the opposite end portions 131a, 31b of the third coil 131 are connected to the oscillation control and frequency conversion part 40, which is disposed on the substrate 116. The coil lengths (widths in the direction indicated by the arrow) of the first coil 121, the second coil 126, and the third coil 131, and their arrangement intervals, are identical to those of the position detection apparatus 1 according to the foregoing example.

Referring to FIG. 16, the moving body 113 includes a shaft portion 114 and a main body 115. The shaft portion 114, which is shaped like a solid cylinder, is coupled to the probe 12 so as to be coaxial with the probe 12, and is supported by an appropriate support member so as to be movable in the direction along its axis. The main body 115, as seen in a front view, has a comb-like shape, and in other words, has a contour line in a square wave shape. The main body 115 has four protruding portions protruding downward in FIG. 16, which serve as detection object portions 115a, 115b, 115c, 115d in this order from the right side. The width of each of the protruding object portions 115a, 115b, 115c, 115d, and the width of each valley portion between them in the direction indicated by the arrow, i.e., the moving direction (displacing direction) are identical to those of the moving body 13 of the position detection apparatus 1 according to the foregoing example. The moving body 113 is provided such that the moving body 113 can displace in the direction indicated by the arrow to pass above the third coil 131, the first coil 121, and the second coil 126, which are arranged in a line, while keeping a predetermined interval between an upper surface of the substrate 116 and lower surfaces of the detection object portions 115a, 115b, 115c, 115d.

The position detection apparatus 100 having such a configuration exerts the same functions and effects as those of the position detection apparatus 1 described above.

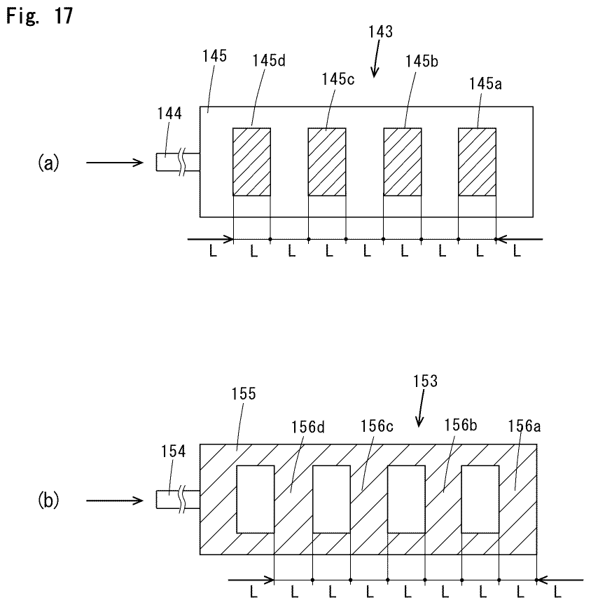

In the position detection apparatus 100, the moving body 113 can adopt an aspect shown in FIG. 17 as a variation.

A moving body 143 shown in FIG. 17(a) includes a shaft portion 144 and a main body 145. The shaft portion 144, which is shaped like a solid cylinder, is coupled to the probe 12 so as to be coaxial with the probe 12, and is supported by an appropriate support member so as to be displaceable in the direction along its axis. The main body 145 has a rectangular shape in a plan view, elongated in its displacing direction (the direction indicated by the arrow), and has rectangular conductors disposed on its surface opposed to the third coil 131, the first coil 121, and the second coil 126, the rectangular conductors being arranged in a line along the displacing direction. The conductors serve as detection object portions 146a, 146b, 146c, 146d in this order from the right side. The width of each of the detection object portions 146a, 146b, 146c, 146d, and the interval between them in the displacing direction (the direction indicated by the arrow) are identical to those of the moving body 13 of the position detection apparatus 1 according to the foregoing example.

A moving body 153 shown in FIG. 17(b) includes a shaft portion 154 and a main body 155. The shaft portion 154, which is shaped like a solid cylinder, is coupled to the probe 12 so as to be coaxial with the probe 12, and is supported by an appropriate support member so as to be displaceable in the direction along its axis. The main body 155 is made of a conductor, and has a rectangular shape in a plan view, elongated in its displacing direction (the direction indicated by the arrow). The main body 155 has four rectangular spaces formed by punching along its longitudinal direction, and remaining portions of the conductor serve as detection object portions 156a, 156b, 156c, 156d in this order from the right side. The width of each of the detection object portions 156a, 156b, 156c, 156d, and the interval between them in the displacing direction (the direction indicated by the arrow) are identical to those of the moving body 13 of the position detection apparatus 1 according to the foregoing example.

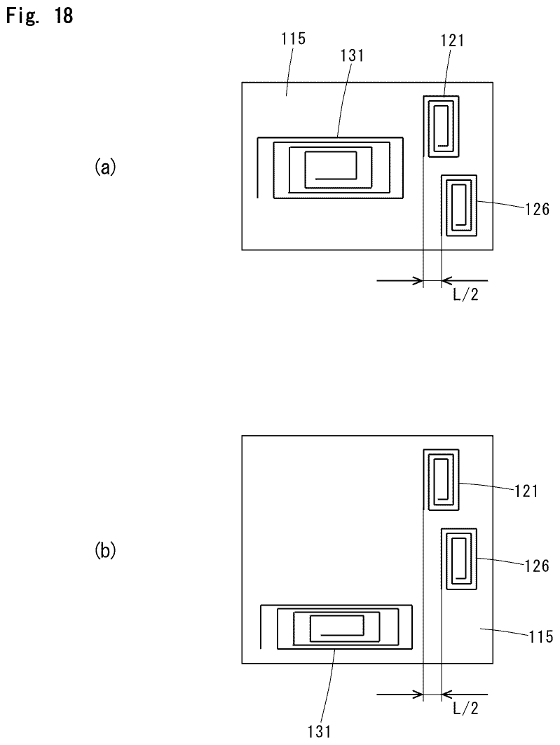

FIG. 18 shows an arrangement that can be an exemplary variation of the arrangement of the third coil 131, the first coil 121, and the second coil 126 on the substrate 116 shown in FIG. 15.

In examples shown in FIGS. 18(a) and (b), the third coil 131, the first coil 121, and the second coil 126 are disposed along the displacing direction of the moving body 113 (the direction indicated by the arrow), with the first coil 121 and the second coil 126 being arranged side by side in a direction perpendicular to the displacing direction (the direction indicated by the arrow). The second coil 126 is shifted by L/2 from the first coil 121 in the displacing direction of the moving body 113 (direction indicated by the arrow). In this example, the interval between the second coil 126 and the first coil 121 in the perpendicular direction can be set to any value. When the number of coils provided as relative displacement detection parts is n, the distance of shifting between ones of the coils in the displacing direction of the moving body 113 (the direction indicated by the arrow) is generalized to be (L±L/n).

The third coil 131 may be arranged inward of the first coil 121 and the second coil 126 in the direction perpendicular to the displacing direction as shown in (a), or may be arranged outward of the second coil 126 in the direction perpendicular to the displacing direction as shown in (b). Alternatively, the third coil 131 may likewise be arranged outward of the first coil 121 in the direction perpendicular to the displacing direction, though not shown. In these cases, the width of the moving body 131 in the direction perpendicular to the displacing direction, and in other words, the width of its detection object portions 115a, 115b, 115c, 115d, is such a width that they overlap the third coil 131, the first coil 121, and the second coil 126 in up-down direction. The same applies to the moving bodies 143 and 153 shown in FIG. 17.

In the foregoing example, the position calculation part 41 and the data storage part 42 are, as the measurement unit 10, disposed in the case 11; however, this configuration is not limiting, and the position calculation part 41 and the data storage part 42 may be disposed separately from the case 11. With such a configuration, the position calculation part 41 and the oscillation control and frequency conversion part 40 are connected by communication means, and the oscillation control and frequency conversion part 40 transmits oscillation frequency data to the position calculation part 41. In this case, the display unit 50 may also be disposed separately from the measurement unit 10, and the: display unit 10 may be formed unitedly with the position calculation part 41 and the data storage part 42.

Alternatively, a configuration may be conceivable in which the measurement unit 10 and the display unit 50 are provided as separate units, and the position calculation part 41 is connected to the display unit 10 by communication means. In this configuration, the position calculation part 41 transmits position data, as a measured value, to the display unit 50, and the measured value is displayed on the display unit 50.

Once again, it should be noted that the description of the embodiment above is in all respects illustrative, and never limiting. Modifications and alterations may be made as appropriate by those skilled in the art. The scope of the present teaching is defined not by the above-described embodiment but by the scope of claims. Furthermore, the scope of the present teaching includes changes from the embodiment within the range equivalent to the scope of claims.

### REFERENCE SIGNS LIST

1: position detection apparatus
10: measurement unit
11: case
12: probe
13: moving body
14: shaft portion
15: detection object portion
15a: first detection object portion
15b: second detection object portion
15c: third detection object portion
15d: fourth detection object portion
20: first detection part
21: winding coil
22: capacitor
25: second detection part
26: winding coil
27: capacitor
30: third detection part
31: winding coil
32: capacitor
40: oscillation control and frequency conversion part
41: position calculation part
42: data storage part
50: display unit

1. A position detection apparatus comprising:
a moving body having an elongated shape, the moving body being disposed so as to be movable in its longitudinal direction, the moving body having plural detection object portions disposed along the longitudinal direction, the plural detection object portions having a conductivity;
plural relative displacement detection parts for detecting a relative displacement of the moving body, the plural relative displacement detection parts being arranged along a moving direction of the moving body, the plural relative displacement detection parts being disposed so as to be capable of facing the respective detection object portions of the moving body with a predetermined interval therebetween; and
a position calculation part for calculating a displacement of the moving body by processing output signals from the relative displacement detection parts,
each of the relative displacement detection parts including a winding coil for forming an LC circuit and a capacitor connected between opposite end portions of the winding coil.

2. The position detection apparatus according to claim 1,
further comprising an absolute position detection part for detecting an absolute position of the moving body, the absolute position detection part being disposed on one or the other side of the relative displacement detection parts in the moving direction of the moving body, the absolute position detection part being disposed so as to be capable of facing the respective detection object portions of the moving body with the predetermined interval therebetween, wherein
the absolute position detection part includes a winding coil for forming an LC circuit and a capacitor connected between opposite end portions of the winding coil, the winding coil having a length longer than that of each of the winding coils of the relative displacement detection parts, and
the position calculation part is configured to detect a position of the moving body by processing output signals from the relative displacement detection parts and the absolute position detection part.

3. The position detection apparatus according to claim 1, wherein
the number of the relative displacement detection parts provided is n, the winding coils of the n relative displacement detection parts have the same length, and provided that the length is L, the winding coils are arranged at an interval of (L±L/n) from one another, and
each of the detection object portions of the moving body has a width in the longitudinal direction equal to the length of each of the winding coils of the relative displacement detection parts, and the detection object portions of the moving body are arranged at a distance from one another, the distance corresponding to the length of each of the winding coils of the relative displacement detection parts.

4. A position detection apparatus comprising:
a moving body having an elongated shape, the moving body being disposed so as to be movable in its longitudinal direction, the moving body having plural detection object portions disposed along the longitudinal direction, the plural detection object portions having a conductivity;
plural relative displacement detection parts for detecting a relative displacement of the moving body, the plural relative displacement detection parts being disposed so as to be capable of facing the respective detection object portions of the moving body with a predetermined interval therebetween, the plural relative displacement detection parts being arranged side by side in a direction perpendicular to a moving direction of the moving body, the plural relative displacement detection parts being arranged one farther in forward direction than another in the moving direction; and
a position calculation part for calculating a displacement of the moving body by processing output signals from the relative displacement detection parts,
each of the relative displacement detection parts including a winding coil and a capacitor, the winding coil being a planar coil for forming an LC circuit, the capacitor being connected between opposite end portions of the winding coil.

5. The position detection apparatus according to claim 4,
further comprising an absolute position detection part for detecting an absolute position of the moving body, the absolute position detection part being disposed on one or the other side of the relative displacement detection parts in the moving direction of the moving body, the absolute position detection part being disposed so as to be capable of facing the respective detection object portions of the moving body with the predetermined interval therebetween, wherein
the absolute position detection part includes a winding coil and a capacitor, the winding coil being a planar coil for forming an LC circuit, the capacitor being connected between opposite end portions of the winding coil, the winding coil of the absolute position detection part having a length longer than that of each of the winding coils of the relative displacement detection parts, and
the position calculation part is configured to detect a position of the moving body by processing output signals from the relative displacement detection parts and the absolute position detection part.

6. The position detection apparatus according to claim 4, wherein
the number of the relative displacement detection parts provided is n, the winding coils of the n relative displacement detection parts have the same length, and provided that the length is L, the winding coils are arranged one farther in the forward direction than another in the moving direction at a distance corresponding to (L±L/n) from one another, and
each of the detection object portions of the moving body has a width in the longitudinal direction equal to the length of each of the winding coils of the relative displacement detection parts.
